(19) United States
(12) Patent Application Publication
(10) Pub. No.: US 2026/0269490 A1
(43) Pub. Date: Sep. 10, 2026

(54) ANTENNA MODULE

(71) Applicant: PEGATRON CORPORATION, TAIPEI CITY (TW)

(72) Inventors: Chien-Yi Wu, Taipei City (TW); Tse-Hsuan Wang, Taipei City (TW); Chi-Yin Fang, Taipei City (TW); Chao-Hsu Wu, Taipei City (TW); Chih-Fu Chang, Taipei City (TW); Hsin-Feng Hsieh, Taipei City (TW)

(73) Assignee: PEGATRON CORPORATION, TAIPEI CITY (TW)

(21) Appl. No.: 19/412,829

(22) Filed: Dec. 8, 2025

(30) Foreign Application Priority Data
Mar. 4, 2025 (TW) 114107987

(51) Int. Cl. H01Q 21/28; H01Q 1/28

(52) U.S. Cl. CPC H01Q 21/28; H01Q 1/28

(57) ABSTRACT

An antenna module is adapted to be disposed in a fuselage of an unmanned aerial vehicle. The fuselage includes front and rear sides opposite to each other and left and right sides opposite to each other. The antenna module includes a first antenna, a second antenna, a third antenna, and a fourth antenna. The first antenna is horizontally disposed on the front side of the fuselage and is a horizontally polarized antenna. The second antenna is vertically disposed on the right side of the fuselage and is a vertically polarized antenna. The third antenna is horizontally disposed on the rear side of the fuselage and is a horizontally polarized antenna. The fourth antenna is vertically disposed on the left side of the fuselage and is a vertically polarized antenna. Each of the first antenna, the second antenna, the third antenna, and the fourth antenna operate in a frequency band.

### CROSS-REFERENCE TO RELATED APPLICATION

This application claims the priority benefit of Taiwan application serial no. 114107987, filed on Mar. 4, 2025. The entirety of the above-mentioned patent application is hereby incorporated by reference herein and made a part of this specification.

### BACKGROUND

### Technical Field

The disclosure relates to an antenna module, and in particular, relates to an antenna module applied to an unmanned aerial vehicle (UAV).

### Description of the Related Art

With the advancement of technology, the development of UAVs has flourished. Since UAVs may have different positions, distances, angles, and movement patterns (such as pitch or roll) with respect to the remote controller during flight, how to effectively receive or transmit signals from different directions is an important issue.

### SUMMARY

The disclosure provides an antenna module with improved transmission and reception capabilities.

The disclosure provides an antenna module adapted to be disposed in a fuselage of an unmanned aerial vehicle (UAV). The fuselage includes a front side and a rear side opposite to each other and a left side and a right side opposite to each other. The antenna module includes a first antenna, a second antenna, a third antenna, and a fourth antenna. The first antenna is horizontally disposed on the front side of the fuselage and is a horizontally polarized antenna. The second antenna is vertically disposed on the right side of the fuselage and is a vertically polarized antenna. The third antenna is horizontally disposed on the rear side of the fuselage and is a horizontally polarized antenna. The fourth antenna is vertically disposed on the left side of the fuselage and is a vertically polarized antenna. Each of the first antenna, the second antenna, the third antenna, and the fourth antenna operates in a frequency band.

To sum up, since the antennas are disposed within all four sides (front, rear, left, and right) of the fuselage, regardless of whether the UAV faces the remote controller with the front side or the rear side and regardless of the pitching or rolling scenario, the antenna module has improved transmission and reception capabilities.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of an appearance of an unmanned aerial vehicle (UAV).

FIG. 2 is a three-dimensional schematic view of an antenna module disposed inside a fuselage of the UAV according to an embodiment of the disclosure.

FIG. 3 is a top schematic view of the antenna module of FIG. 2.

FIG. 4 is a partial schematic view of FIG. 3.

FIG. 5 is a top schematic view of an antenna module according to another embodiment of the disclosure.

FIG. 6 is a schematic view of a switching circuit of the antenna module of FIG. 2.

FIG. 7 is radiation field patterns of a second antenna and a fourth antenna of FIG. 2 when a front side of the UAV faces toward a remote controller and pitches.

FIG. 8 is radiation field patterns of the second antenna and the fourth antenna of FIG. 2 when a rear side of the UAV faces toward the remote controller and pitches.

FIG. 9 is radiation field patterns of the second antenna and the fourth antenna of FIG. 2 when the front side of the UAV faces toward the remote controller and rolls.

FIG. 10 is radiation field patterns of the second antenna and the fourth antenna of FIG. 2 when the rear side of the UAV faces toward the remote controller and rolls.

### DESCRIPTION OF THE EMBODIMENTS

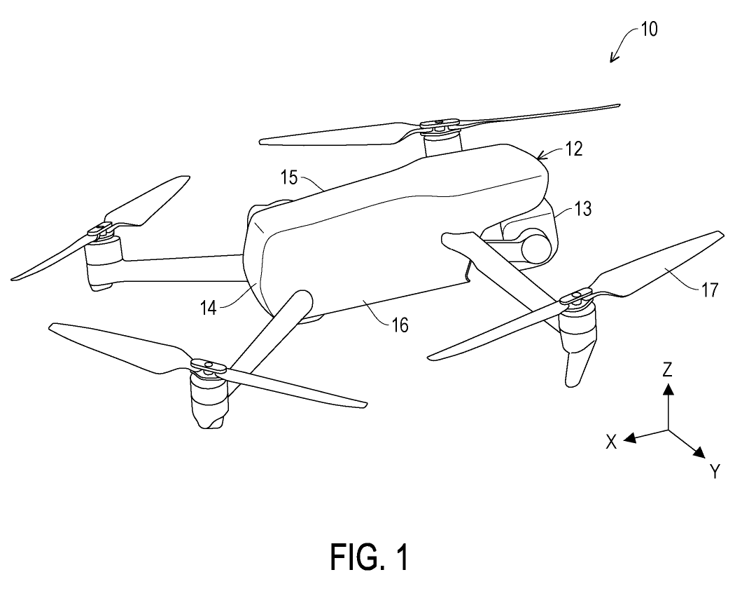

FIG. 1 is a schematic view of an appearance of an unmanned aerial vehicle (UAV). Referring to FIG. 1, a fuselage 12 of an UAV 10 includes a front side 13 and a rear side 14 opposite to each other and a left side 15 and a right side 16 opposite to each other. The front side 13 is, for example, a nose, and the rear side 14 is, for example, a tail. A plurality of sets of wings 17 (propellers) are provided around the fuselage 12.

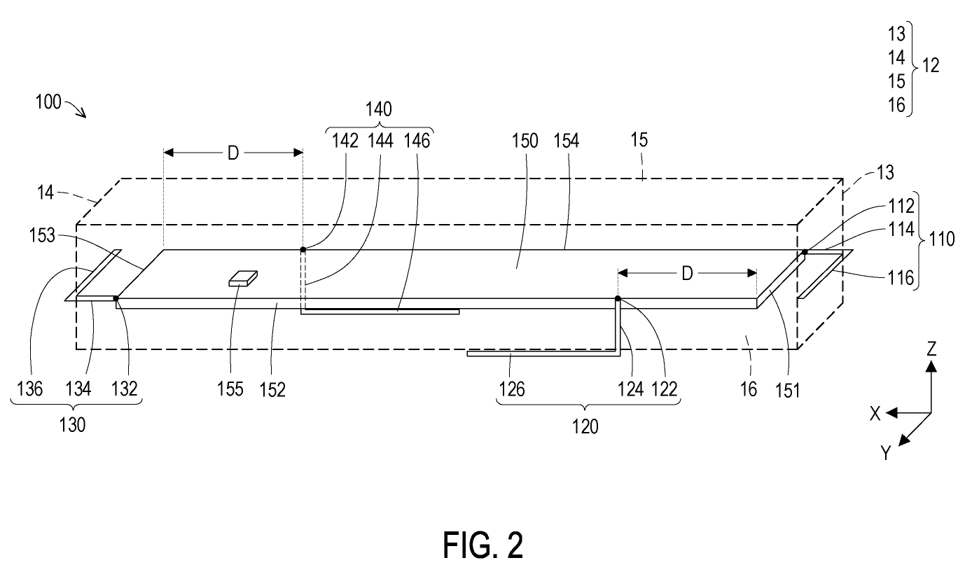

In this embodiment, an antenna module 100 (FIG. 2) is disposed on an inner wall of a housing of the fuselage 12. Through a special design, the antenna module 100 may have improved transmission and reception capabilities regardless of whether the UAV 10 faces toward a remote controller with the front side 13 or the rear side 14, and regardless of whether the UAV 10 is in a scenario of pitching or rolling. Further, the influence of the wings 17 (propellers) on antenna signals may be decreased. Description is provided in the following paragraphs.

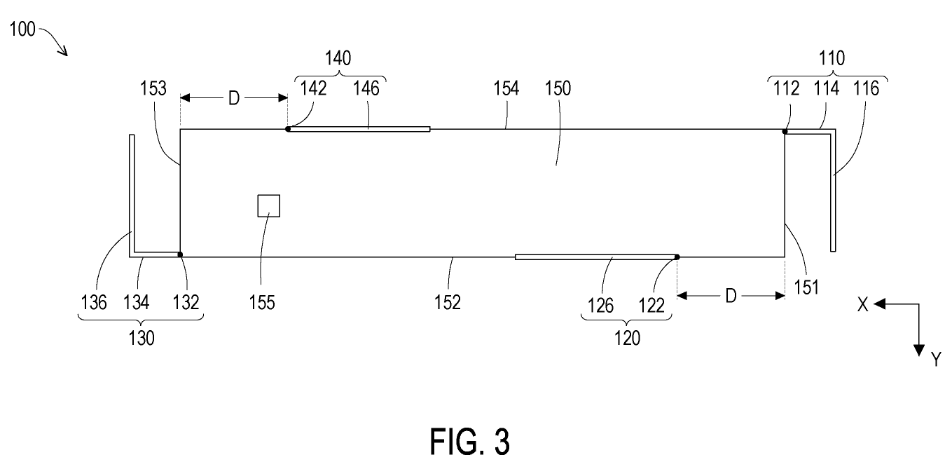

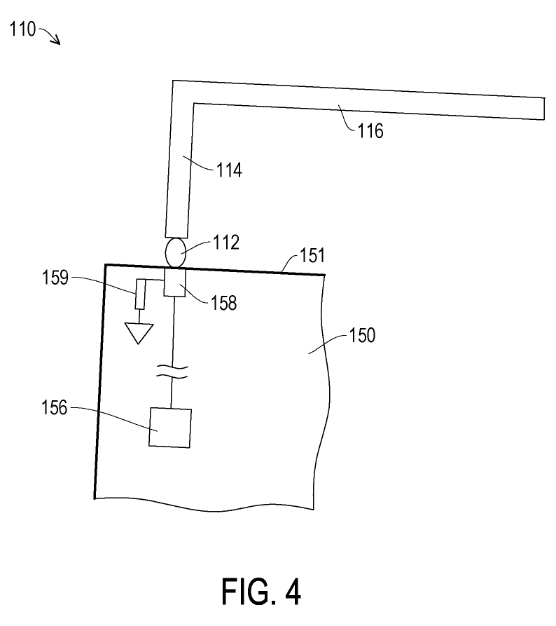

FIG. 2 is a three-dimensional schematic view of an antenna module disposed inside a fuselage of the UAV according to an embodiment of the disclosure. FIG. 3 is a top schematic view of the antenna module of FIG. 2. FIG. 4 is a partial schematic view of FIG. 3. It should be noted that in FIG. 2, the fuselage 12 of the UAV 10 is simplified and represented by a rectangular parallelepiped with dashed lines, which is slightly different from the shape of the fuselage 12 in FIG. 1. In addition, FIG. 4 is a partial area of the upper right portion of FIG. 3, viewed after rotating counterclockwise, and some components in FIG. 4 are not shown in FIG. 3.

Referring to FIG. 2 to FIG. 4, in this embodiment, the antenna module 100 includes a first antenna 110, a second antenna 120, a third antenna 130, and a fourth antenna 140. The first antenna 110 is horizontally disposed on the front side 13 of the fuselage 12 and is a horizontally polarized antenna. The second antenna 120 is vertically disposed on the right side 16 of the fuselage 12 and is a vertically polarized antenna. The third antenna 130 is horizontally disposed on the rear side 14 of the fuselage 12 and is a horizontally polarized antenna. The fourth antenna 140 is vertically disposed on the left side 15 of the fuselage 12 and is a vertically polarized antenna.

Therefore, the first antenna 110 and the third antenna 130 constitute a set of horizontally polarized complementary configuration, and the second antenna 120 and the fourth antenna 140 constitute a set of vertically polarized complementary configuration.

The first antenna 110, the second antenna 120, the third antenna 130, and the fourth antenna 140 all operate in a same frequency band. In this embodiment, the frequency band is, for example, 802.11ah, between 863MHz and 928MHz, but it is not limited thereto. In addition, in this embodiment, a length of each of the first antenna 110, the second antenna 120, the third antenna 130, and the fourth antenna 140 is between 0.2 times and 0.3 times a wavelength of the frequency band, for example, 0.25 times the wavelength.

The antenna module 100 further includes a circuit board 150 disposed within the fuselage 12. The circuit board 150 includes a first short side 151 and a second short side 153 opposite to each other and a first long side 152 and a second long side 154 opposite to each other. The first short side 151 faces toward, for example, the front side 13 of the fuselage 12, the second short side 153 faces toward, for example, the rear side 14 of the fuselage 12, the first long side 152 faces toward, for example, the right side 16 of the fuselage 12, and the second long side 154 faces toward, for example, the left side 15 of the fuselage 12.

The circuit board 150 is connected to the first antenna 110, the second antenna 120, the third antenna 130, and the fourth antenna 140. In this embodiment, each of the first antenna 110, the second antenna 120, the third antenna 130, and the fourth antenna 140 is L-shaped, so as to be disposed in the limited space within the fuselage 12 and provide a corresponding horizontal or vertical polarization function. Certainly, the shapes of the first antenna 110, the second antenna 120, the third antenna 130, and the fourth antenna 140 are not limited thereto.

As shown in FIG. 2, the first antenna 110 is coplanar with the circuit board 150. The first antenna 110 includes a first feeding terminal 112, a first segment 114 extending from the first feeding terminal 112 along the second long side 154, and a second segment 116 perpendicularly connected to the first segment 114. The first feeding terminal 112 is connected to a portion of the first short side 151 near the second long side 154, for example, at a junction of the first short side 151 and the second long side 154, but a position of the first feeding terminal 112 is not limited thereto.

As shown in FIG. 4, in this embodiment, the first feeding terminal 112 of the first antenna 110 contacts an elastic piece 158 on the circuit board 150. The elastic piece 158 on the circuit board 150 is connected to ground through an inductor 159 and is also connected to a signal terminal of a chip 156 on the circuit board 150. The second antenna 120, the third antenna 130, and the fourth antenna 140 are connected to the circuit board 150 in the same manner, so description thereof is not repeated herein.

Referring to FIG. 2 again, the first segment 114 of the first antenna 110 extends, for example, along the second long side 154, and the second segment 116 of the first antenna 110 extends, for example, from the second long side 154 toward the first long side 152, and is parallel to the first short side 151.

The second antenna 120 includes a second feeding terminal 122, a third segment 124 extending from the second feeding terminal 122, and a fourth segment 126 perpendicularly connected to the third segment 124. The second feeding terminal 122 is connected to a portion of the first long side 152 near the first short side 151. In this embodiment, a distance D between the second antenna 120 and the first short side 151 is between 0.09 times and 0.1 times the wavelength of the frequency band.

The third segment 124 of the second antenna 120 extends in a normal direction of the circuit board 150. The fourth segment 126 of the second antenna 120 is parallel to the circuit board 150 and extends toward the second short side 153 in a manner parallel to the first long side 152, for example.

The third antenna 130 is coplanar with the circuit board 150. The third antenna 130 includes a third feeding terminal 132, a fifth segment 134 extending from the third feeding terminal 132 along the first long side 152, and a sixth segment 136 bendingly connected to the fifth segment 134. The third feeding terminal 132 is connected to a portion of the second short side 153 near the first long side 152, for example, at a junction of the second short side 153 and the first long side 152, but a position of the third feeding terminal 132 is not limited thereto.

The fifth segment 134 of the third antenna 130 extends, for example, along the first long side 152, and the sixth segment 136 of the third antenna 130 extends, for example, from the first long side 152 toward the second long side 154 and is parallel to the second short side 153.

The fourth antenna 140 includes a fourth feeding terminal 142, a seventh segment 144 extending from the fourth feeding terminal 142, and an eighth segment 146 bendingly connected to the seventh segment 144. The fourth feeding terminal 142 is connected to a portion of the second long side 154 near the second short side 153. In this embodiment, a distance D between the fourth antenna 140 and the second short side 153 is between 0.09 times and 0.1 times the wavelength of the frequency band.

The seventh segment 144 of the fourth antenna 140 extends in the normal direction of the circuit board 150. The eighth segment 146 of the fourth antenna 140 is parallel to the circuit board 150 and extends toward the first short side 151 in a manner parallel to the second long side 154, for example.

As can be seen from FIG. 2, in this embodiment, the first feeding terminal 112 and the third feeding terminal 132 are located at two diagonal corners of the circuit board 150, and the first antenna 110 and the third antenna 130 have symmetrical shapes. As such, the shape of the first antenna 110 after rotating 180 degrees around the normal direction of the circuit board 150 as an axis is close to the shape of the third antenna 130.

Further, the second feeding terminal 122 and the fourth feeding terminal 142 are located at two long sides of the circuit board 150, and the second antenna 120 and the fourth antenna 140 have symmetrical shapes. As such, the shape of the second antenna 120 after rotating 180 degrees around the normal direction of the circuit board 150 as an axis is close to the shape of the fourth antenna 140.

It should be noted that horizontally polarized antennas are mainly used when a distance between the remote controller (not shown) and the UAV 10 is a short distance. Due to the short distance, the signal is relatively strong. In this embodiment, the first antenna 110 and the third antenna 130 may not have segments extending in the normal direction of the circuit board 150. However, in other embodiments, the first antenna 110 and the third antenna 130 may also have segments extending in the normal direction of the circuit board 150.

Further, vertically polarized antennas are mainly used when the distance between the remote controller and the UAV 10 is a long distance. Due to the long distance, the signal is relatively weak. Therefore, each of the second antenna 120 and the fourth antenna 140 has a segment extending along an edge of the circuit board 150 and a segment extending in the normal direction of the circuit board 150, so as to further enhance the transmission/reception capabilities of the UAV 10 in different operating states. Certainly, the shapes of the second antenna 120 and the fourth antenna 140 are not limited thereto.

In FIG. 3, the first antenna 110, the second antenna 120, the third antenna 130, and the fourth antenna 140 are arranged in a clockwise direction, but the arrangement of the first antenna 110, the second antenna 120, the third antenna 130, and the fourth antenna 140 is not limited thereto.

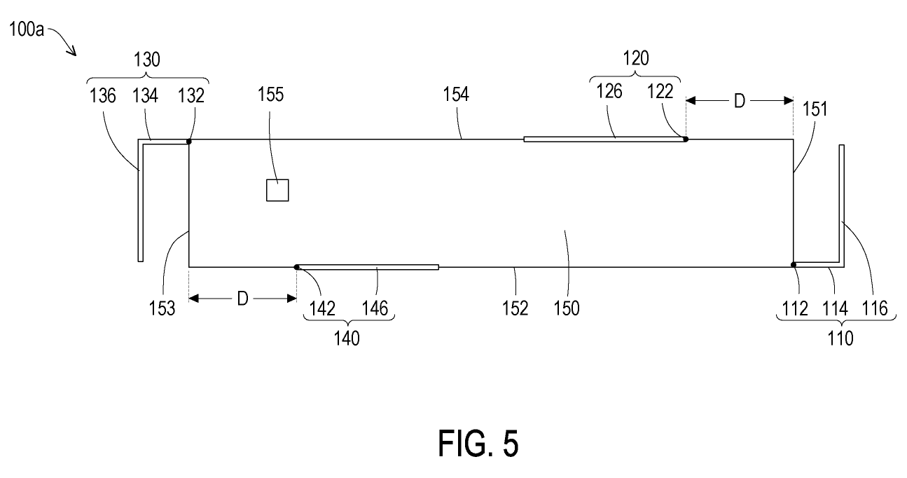

FIG. 5 is a top schematic view of an antenna module according to another embodiment of the disclosure. Referring to FIG. 5, the first antenna 110, the second antenna 120, the third antenna 130, and the fourth antenna 140 are arranged in a counterclockwise direction. Similarly, an antenna module 100a of this embodiment has improved transmission and reception capabilities because the first antenna 110 and the third antenna 130 form a set of horizontally polarized complementary configuration, and the second antenna 120 and the fourth antenna 140 form a set of vertically polarized complementary configuration.

Referring to FIG. 2 again, the circuit board 150 of the antenna module 100 of this embodiment may dynamically select one of the first antenna 110, the second antenna 120, the third antenna 130, and the fourth antenna 140 to perform antenna signal transmission according to the transmission and reception states of the first antenna 110, the second antenna 120, the third antenna 130, and the fourth antenna 140.

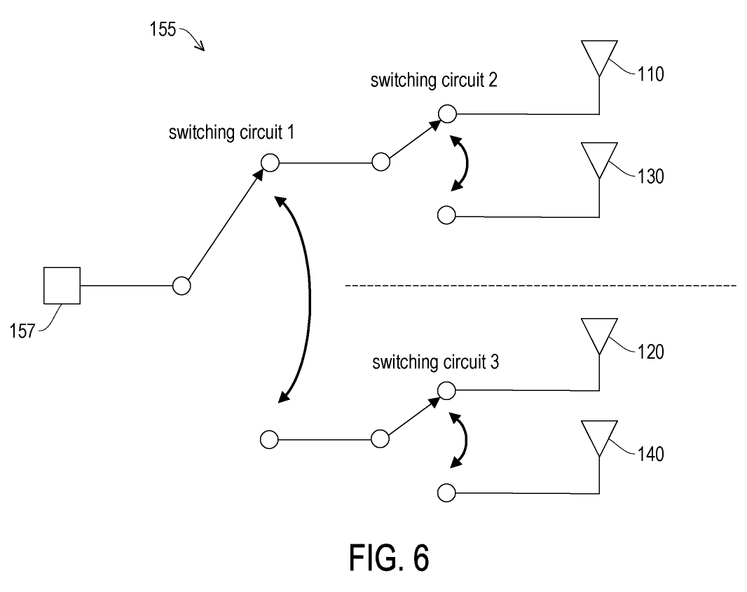

FIG. 6 is a schematic view of a switching circuit of the antenna module of FIG. 2. Referring to FIG. 6, in this embodiment, the circuit board 150 includes a switching circuit 155 electrically connected to one of the first antenna 110, the second antenna 120, the third antenna 130, and the fourth antenna 140 selectively.

To be specific, a RF module input/output terminal 157 selects a horizontally polarized antenna or a vertically polarized antenna through a switching circuit 1 to perform transmission/reception wireless transmission. If the horizontally polarized antenna is selected, the switching circuit 1 switches to the upper side. If the vertically polarized antenna is selected, the switching circuit 1 switches to the lower side.

According to the switching circuit 1 switching to the upper side or lower side, a switching circuit 2 or a switching circuit 3 correspondingly perform switching subsequently. The switching circuit 2 is used to select the antenna with the optimal transmission/reception strength in the horizontally polarized direction. If the first antenna 110 is selected, the switching circuit 2 switches to the upper side. If the third antenna 130 is selected, the switching circuit 2 switches to the lower side.

The switching circuit 3 is used to select the antenna with the optimal transmission/reception strength in the vertically polarized direction. If the second antenna 120 is selected, the switching circuit 3 switches to the upper side. If the fourth antenna 140 is selected, the switching circuit 3 switches to the lower side.

When the UAV 10 performs wireless transmission with the remote controller (not shown), if the remote controller is preset to a fixed state, the UAV 10 will pitch and roll within ±60 degrees during flight. In this embodiment, the antenna module 100 synthesizes an optimal radiation field pattern through the polarization and complementary manner of the first antenna 110 and the third antenna 130 as well as the second antenna 120 and the fourth antenna 140, so as to improve a coverage range and strength of transmission/reception signals.

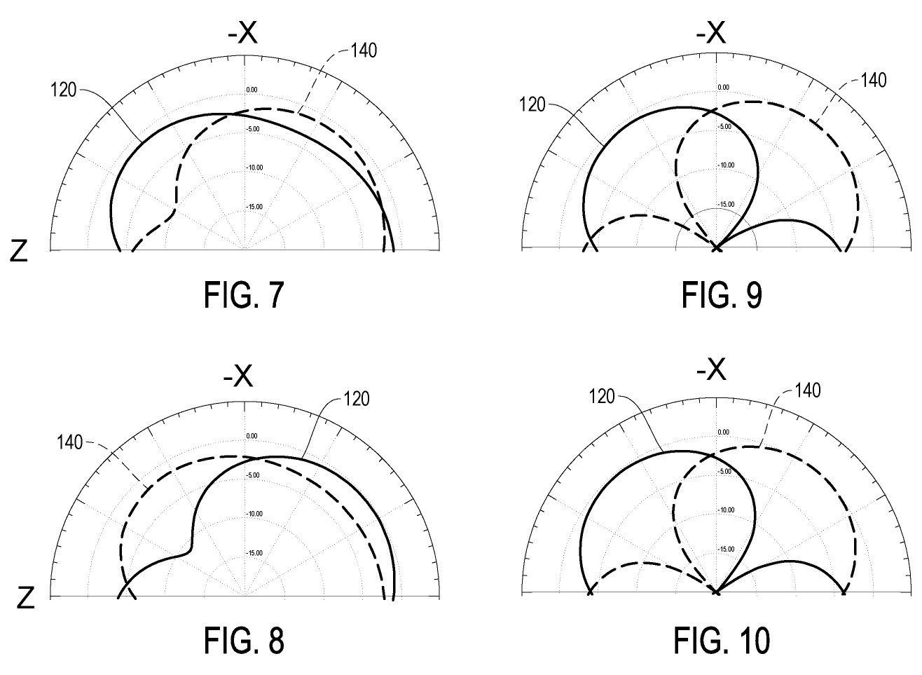

FIG. 7 is radiation field patterns of a second antenna and a fourth antenna of FIG. 2 when a front side of the UAV faces toward a remote controller and pitches. Referring to FIG. 7, FIG. 7 shows the front side 13 (nose) of the UAV 10 facing the remote controller, and the front side 13 and the rear side 14 of the UAV 10 swing in opposite up-and-down directions, presenting a nodding-like state. The radiation field pattern of the second antenna 120 is represented by a solid line, and the radiation field pattern of the fourth antenna 140 is represented by a dashed line. As can be seen from FIG. 7, the second antenna 120 and the fourth antenna 140 are complementary in terms of the radiation field patterns.

FIG. 8 is radiation field patterns of the second antenna and the fourth antenna of FIG. 2 when a rear side of the UAV faces toward the remote controller and pitches. Referring to FIG. 8, FIG. 8 shows the rear side 14 (tail) of the UAV 10 facing the remote controller, and the front side 13 and the rear side 14 of the UAV 10 swing in opposite up-and-down directions, presenting a nodding-like state. The radiation field pattern of the second antenna 120 is represented by a solid line, and the radiation field pattern of the fourth antenna 140 is represented by a dashed line. As can be seen from FIG. 8, the second antenna 120 and the fourth antenna 140 are complementary in terms of the radiation field patterns.

FIG. 9 is radiation field patterns of the second antenna and the fourth antenna of FIG. 2 when the front side of the UAV faces toward the remote controller and rolls. Referring to FIG. 9, FIG. 9 shows the front side 13 (nose) of the UAV 10 facing the remote controller, and the wing 17 of the left side 15 and the wing 17 of the right side 16 of the UAV 10 swing in opposite up-and-down directions. The radiation field pattern of the second antenna 120 is represented by a solid line, and the radiation field pattern of the fourth antenna 140 is represented by a dashed line. As can be seen from FIG. 9, the second antenna 120 and the fourth antenna 140 are complementary in terms of the radiation field patterns.

FIG. 10 is radiation field patterns of the second antenna and the fourth antenna of FIG. 2 when the rear side of the UAV faces toward the remote controller and rolls. Referring to FIG. 10, FIG. 10 shows the rear side 14 (tail) of the UAV 10 facing the remote controller, and the wing 17 of the left side 15 and the wing 17 of the right side 16 of the UAV 10 swing in opposite up-and-down directions. The radiation field pattern of the second antenna 120 is represented by a solid line, and the radiation field pattern of the fourth antenna 140 is represented by a dashed line. As can be seen from FIG. 10, the second antenna 120 and the fourth antenna 140 are complementary in terms of the radiation field patterns.

As can be seen from FIG. 7 to FIG. 10, regardless of whether the UAV 10 faces the remote controller with the front side 13 or the rear side 14 and regardless of whether the UAV 10 pitches or rolls due to wind disturbance, the main polarization and cross polarization field patterns of the second antenna 120 and the fourth antenna 140 are both full and complementary. Therefore, even when the UAV 10 is flipped to an angle of ±90 degrees while being paired with the remote controller, the antenna module 100 may still select the antennas with favorable transmission/reception capabilities in different polarization directions, so that the transmission and reception capabilities of the antenna module 100 may both maintain good performance.

Further, the radiation field patterns of the second antenna 120 and the fourth antenna 140 are applied to the shooting and bouncing Ray (SBR) tracking algorithm of simulation software, so as to simulate and predict an electromagnetic wave transmission path and channel characteristics between the UAV 10 and the remote controller. When the UAV 10 pitches and rolls (pitch/roll range of ±60 degrees), regardless of whether the front side 13 (nose) of the UAV 10 approaches or moves away from the remote controller, communication evaluation results at a distance of 30 kilometers may all achieve transmission rates above 6.5 Mbps and comply with the video transmission bit rate specifications of AV1 and H.265 (1440p/60fps), good performance is thus provided.

In addition, through simulation, when the UAV 10 is at a height of 100 meters above ground and at a distance of 40 kilometers from the remote controller, a receiving antenna (Gr) gain of the UAV 10 is 1dBi, and a transmitting antenna (Gt) gain of the remote controller is 1dBi. If the 802.11ah (915MHz) frequency is selected, through simulation software calculation, when the transmission power (Pt) is 28dBm, the reception power (Pr) at a distance of 40km is -93.7dBm, which is greater than the specification of -93dBm and may comply with the requirements.

In view of the foregoing, in to the disclosure, the first antenna of the antenna module is horizontally disposed on the front side of the fuselage and is a horizontally polarized antenna. The second antenna is vertically disposed on the right side of the fuselage and is a vertically polarized antenna. The third antenna is horizontally disposed on the rear side of the fuselage and is a horizontally polarized antenna. The fourth antenna is vertically disposed on the left side of the fuselage and is a vertically polarized antenna. Each of the first antenna, the second antenna, the third antenna, and the fourth antenna operates in a frequency band. Since the antennas are disposed within all four sides (front, rear, left, and right) of the fuselage, regardless of whether the UAV faces the remote controller with the front side or the rear side and regardless of the pitching or rolling scenario, the antenna module may have improved transmission and reception capabilities.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An antenna module adapted to be disposed in a fuselage of an unmanned aerial vehicle (UAV), the fuselage comprising a front side and a rear side opposite to each other and a left side and a right side opposite to each other, the antenna module comprising:
a first antenna, horizontally disposed on the front side of the fuselage, operating in a frequency band, and being a horizontally polarized antenna;
a second antenna, vertically disposed on the right side of the fuselage, operating in the frequency band, and being a vertically polarized antenna;
a third antenna, horizontally disposed on the rear side of the fuselage, operating in the frequency band, and being a horizontally polarized antenna; and
a fourth antenna, vertically disposed on the left side of the fuselage, operating in the frequency band, and being a vertically polarized antenna.

2. The antenna module according to claim 1, wherein a length of each of the first antenna, the second antenna, the third antenna, and the fourth antenna is between 0.2 times and 0.3 times a wavelength of the frequency band.

3. The antenna module according to claim 1, wherein each of the first antenna, the second antenna, the third antenna, and the fourth antenna is L-shaped.

4. The antenna module according to claim 1, further comprising:
a circuit board disposed within the fuselage and connected to the first antenna, the second antenna, the third antenna, and the fourth antenna.

5. The antenna module according to claim 4, wherein the circuit board comprises a first short side and a second short side opposite to each other, a distance between the second antenna and the first short side is between 0.09 times and 0.1 times a wavelength of the frequency band, and a distance between the fourth antenna and the second short side is between 0.09 times and 0.1 times the wavelength of the frequency band.

6. The antenna module according to claim 4, wherein the circuit board comprises a switching circuit electrically connected to one of the first antenna, the second antenna, the third antenna, and the fourth antenna selectively.

7. The antenna module according to claim 4, wherein the circuit board comprises a first short side and a second short side opposite to each other and a first long side and a second long side opposite to each other, the first antenna comprises a first feeding terminal connected to a portion on the first short side near the second long side, the second antenna comprises a second feeding terminal connected to a portion on the first long side near the first short side, the third antenna comprises a third feeding terminal connected to a portion on the second short side near the first long side, and the fourth antenna comprises a fourth feeding terminal connected to a portion on the second long side near the second short side.

8. The antenna module according to claim 7, wherein the first antenna comprises a first segment extending from the first feeding terminal along the second long side and a second segment perpendicularly connected to the first segment and extending toward the first long side, the second antenna comprises a third segment extending from the second feeding terminal and a fourth segment perpendicularly connected to the third segment, the third segment extends in a normal direction of the circuit board, the fourth segment extends toward the second short side, the third antenna comprises a fifth segment extending from the third feeding terminal along the first long side and a sixth segment bendingly connected to the fifth segment and extending toward the second long side, the fourth antenna comprises a seventh segment extending from the fourth feeding terminal and an eighth segment bendingly connected to the seventh segment, the seventh segment extends in the normal direction of the circuit board, and the eighth segment extends toward the first short side.

9. The antenna module according to claim 8, wherein the first antenna and the third antenna are coplanar with the circuit board, and the fourth segment of the second antenna and the eighth segment of the fourth antenna are parallel to the circuit board.

10. The antenna module according to claim 1, wherein the frequency band is between 863MHz and 928MHz.
